(19) United States
(12) Patent Application Publication
(10) Pub. No.: US 2019/0072402 A1
(43) Pub. Date: Mar. 7, 2019

(54) TACTILE USER CONTROLLER FOR AN AUDIO SYSTEM

(71) Applicant: AUDIOCONEXUS INC., Kingston (CA)

(72) Inventors: Jonathan Stanley, Kingston (CA); Ronald Thatcher, King City (CA); Chris Pearen, King City (CA)

(73) Assignee: AudioConexus Inc.

(21) Appl. No.: 15/695,315

(22) Filed: Sep. 5, 2017

(51) Int. Cl. G01C 21/36; G09B 21/00

(52) U.S. Cl. CPC G01C 21/36; G09B 21/004

(57) ABSTRACT

A user controller for a tourist vehicle's audio system that is linked to a control box. GPS technology is used to track the global location of the vehicle and thereby of the user controller. The user controller includes a housing having a contoured contact surface with one or more recessed tactile controls and a display screen. Backlit graphic indicia and Braille characters are provided adjacent the tactile controls to let a user know what function each tactile control actuates. Capacitance sensors are located below a contact surface of each tactile control. Adjacent tactile controls are separated by raised regions, the height and width of which are different based on whether the tactile controls on either side of the raised region are directed to related functions or not. Pre-recorded messages, including local advertising related to the global position of the vehicle are played when the user controller is activated.

### BACKGROUND

### Technical Field

This disclosure is directed generally to audio equipment. More particularly, the disclosure relates to audio equipment that is provided in tourist transportation. Specifically, this disclosure relates to user controller for an audio system that includes tactile controls.

### Background Information

When people visit new places on vacation it is common for them to join tours that show them around popular sites at their destination. In many cities, particularly in Europe, it is common for buses, boats, trains, museums, and attractions to include systems that enable tourists to hear information about the city or tourist site in their own language. For example, on a glass-topped tour boat, a tourist can sit in their seat, put on a set of headphones and, using a menu on a controller provided at their seat, select the language of their choice. A master control box for the system may include programming and a Global Positioning System (GPS) that monitors the position of the tour boat. As appropriate sites of interest are reached, an automated message will be played that informs the tourist of appropriate and interesting facts about the location of interest. In between stops, music or other messages may be played over the audio system.

It is typical for such audio systems to include a single main electronics computer control box and multiple user controllers. The main computer control box has GPS capabilities and is programmed with many prerecorded messages in multiple languages for various locations along a tour route. The GPS allows the control box to monitor the position of the boat or bus, for example, and to coordinate the messages that may be played over the user controller. The GPS enabled vehicle or vessel user controller may include an information selection button that enables a person to make additional location specific selections. Those selections may be prompted and or confirmed with a digital display on the user controller and may provide information or advertising about the surrounding area through which the tourist vehicle or vessel is traveling.

Each user controller may be mounted on the back of a seat located in front of a tourist or on an armrest, or a sidewall for example. Before the tour starts, the passenger selects a language of choice from a menu of two to forty-eight possible languages or tour topics. Headsets or earbuds may be provided or the user may use their own headsets. The headsets may be operatively engaged with the closest user controller. This ensures that the tourists can easily hear the prerecorded message in their language of choice without disturbing other passengers. This also reduces the changes that passengers will be bombarded with multiple recordings in several language each time a tourist site is reached. As the vehicle approaches the point of interest, the user controller will play the prerecorded message for the passenger's enjoyment. A message such as “The Notre Dame Cathedral is coming up on our right. The Cathedral was built in . . . ”. When the tour is complete, the main controller will reset the messages for the start of a new tour.

The environment in which these audio systems are used is very challenging. The light levels in the boat or bus may vary from bright sunlight to low light on cloudy days, to darkness in the evenings. There may be extreme temperature fluctuations, rain or other moisture, a lot of bouncing around as the vehicle or vessel moves and inexperienced tourist operators who may manhandle the system in their attempts to make it function. In addition the viewing angles and user inputs can be challenging because of the locations in which the systems have to be installed.

### SUMMARY

There remains a need in the art for an improved audio system for tourist venues and particularly for vehicles and vessels used to transport tourists; which is easy to operate and can handle the rigors of the environment to which the system is subjected.

A user controller for a tourist vehicle's audio system is linked to a master control box provided on the tourist vehicle or vessel. GPS technology is used to track the global location of the vehicle and thereby of the user controller. The user controller includes a housing having a contoured contact surface with one or more recessed tactile controls and a display screen. Backlit graphic indicia and Braille characters are provided adjacent the tactile controls to let a user know what function each tactile control actuates. Capacitance sensors are located below a contact surface of each tactile control. Adjacent tactile controls are separated by raised regions, the height and width of which are different based on whether the tactile controls on either side of the raised region are directed to related functions or not. Pre-recorded messages, including local advertising related to the global position of the vehicle are played when the user controller is activated.

In one aspect, the present disclosure may provide a tactile user controller for an audio system comprising a housing adapted to be mounted on a support surface; wherein the housing includes a user contact surface; and one or more tactile controls provided on the user contact surface; wherein the one or more tactile controls are recessed within the user contact surface. The one or more tactile controls may include a actuation region; and an annular wall extending upwardly and outwardly from a perimeter of the actuation region. A capacitance sensor may be positioned adjacent an interior surface of the one or more tactile controls, in particular beneath the actuation region thereof.

In another aspect, the present disclosure may provide a method of operating a user controller of an audio system comprising providing a user controller that includes a housing with a user contact surface with one or more tactile controls provided thereon; wherein each of the one or more tactile controls is recessed within the user contact surface; selecting a first tactile control from the one or more tactile controls; placing a fingertip onto a actuation region provided on the first tactile control; and actuating a first function of the user controller associated with the first tactile control. The placing of the fingertip is followed by activating a capacitance sensor located beneath an interior surface of the actuation region of the first tactile control; activating a microprocessor operatively engaged with the actuation region when the fingertip is placed on the actuation region; and controlling the first function with the microprocessor.

The method may further comprise selecting a second tactile control from the one or more tactile controls; sliding the fingertip from the actuation region of the first tactile control up a first sloped wall, over a first raised region and down a second sloped wall to a second actuation region; activating a capacitance sensor located beneath an interior surface of the second actuation region; and actuating a second function of the user controller associated with the second tactile control.

The sliding over the first raised region includes moving for a first distance upwardly along the first sloped wall to a top of the first raised region when the first function and second function are related to each other; and the sliding over the first raised region includes moving upwardly along the first sloped wall to the top of the first raised region for a second distance when the first function and second function are unrelated; and wherein the second distance is greater than the first distance. The tactile controls 18b and 18c or 20b and 20c may be considered to be laterally or longitudinally spaced from each other depending on the orientation of the viewer. The tactile controls 18b and 20b or 18c and 20c may also be considered to be laterally or longitudinally spaced from each other

The method may further comprise displaying information about the first function on a display screen provided on a user contact surface of the user controller and Illuminating a graphic display provided on the actuation region of the first tactile control. The method may further comprise playing a pre-recorded message when the first tactile control is contacted. Furthermore, the playing of the pre-recorded message comprises playing pre-recorded advertising messages or information messages directed to an area surrounding a location of the user controller. The method may further include utilizing global positioning satellite (GPS) technology programmed into a microprocessor of the master control box for multiple user controllers or of a vessel or vehicle in which the user controller is used to determine a global location of the user controller; and selecting and playing a pre-recorded message on the user controller based on the global location of the user controller.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a top right side perspective view of a user controller for an audio system in accordance with an aspect of the present disclosure;

FIG. 2 is a top left side perspective view of the user controller of FIG. 1;

FIG. 3 is a top plan view of the user controller;

FIG. 4 is left side elevation view thereof;

FIG. 5 is a rear elevation view thereof;

FIG. 6 is a front elevation view thereof;

FIG. 7 is a rear elevation view thereof;

FIG. 8 is a longitudinal cross-section of the user controller taken along line 8-8 of FIG. 3;

FIG. 9 is a longitudinal cross-section of the user controller as shown in FIG. 8 and in which the lengths of the first and third button zones and the depths thereof are identified;

FIG. 10 is a lateral cross-section of the user controller taken along line 10-10 of FIG. 3;

FIG. 11 is a lateral cross-section of the user controller taken along line 11-11 of FIG. 3;

FIG. 12 is a top plan view of the PCB shown on its own with all components removed except for the capacitance sensors, the digital display and the audio connector;

FIG. 13 is an exploded top right side perspective view of the user controller;

FIG. 14 is a side elevation view showing the user controller mounted on a seat back and being used by a tourist;

FIG. 15 is a side elevation view showing the user controller mounted on an armrest and being used by a tourist;

FIG. 16 is a front elevation view showing the user controller mounted on a wall adjacent a seat and being used by a tourist;

FIG. 17 is a front perspective view showing the user engaging the user controller and sliding their finger from a first control button to a second control button;

FIG. 18 is a longitudinal cross-section of FIG. 17; and

FIG. 19 is a front perspective view showing the user depressing an additional control button; and

FIG. 20 is a longitudinal cross-section of FIG. 19.

Similar numbers refer to similar parts throughout the drawings.

### DETAILED DESCRIPTION

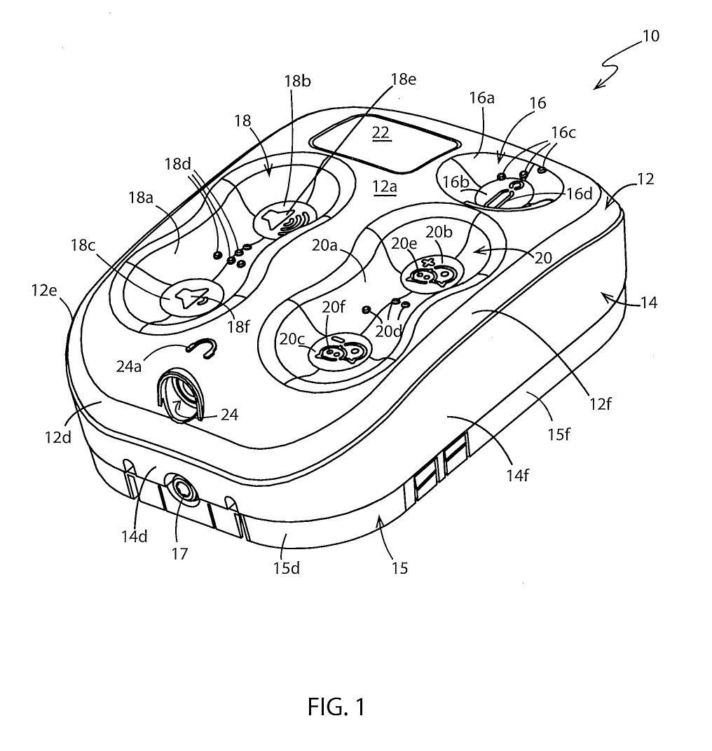

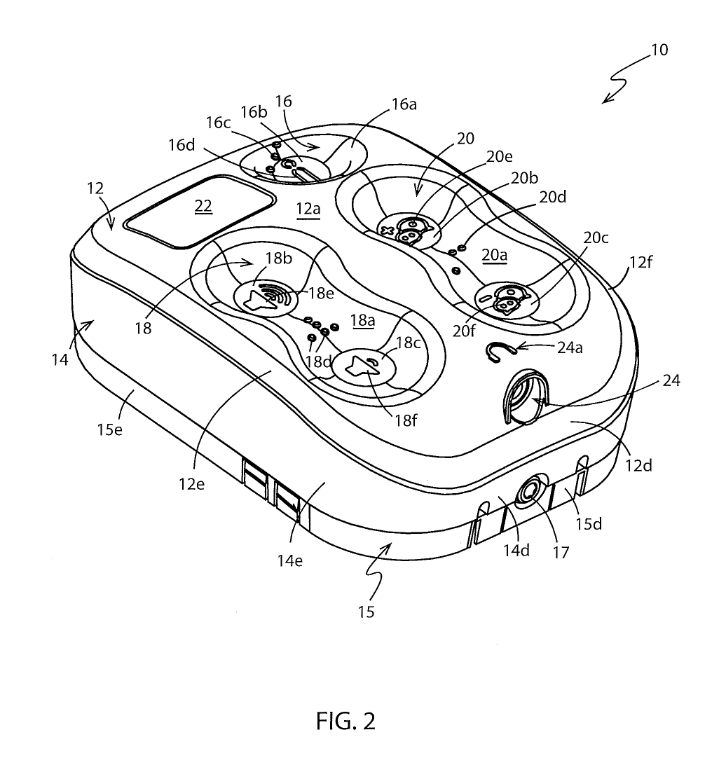

Referring to FIGS. 1-13, there is shown a user controller for a tourism audio system, generally indicated at 10. Controller 10 may include an upper housing 12 and a lower housing 14 that are configured to be complementarily engaged with each other. Lower housing 14 is configured to engage a mounting bracket 15 that is mounted on a seatback, armrest, wall or other surface in a tour bus or tour boat. It will be understood that in other instances, mounting bracket 15 and thereby user controller 10 may be mounted on a wall, post or other surface of a building or in any other desired location.

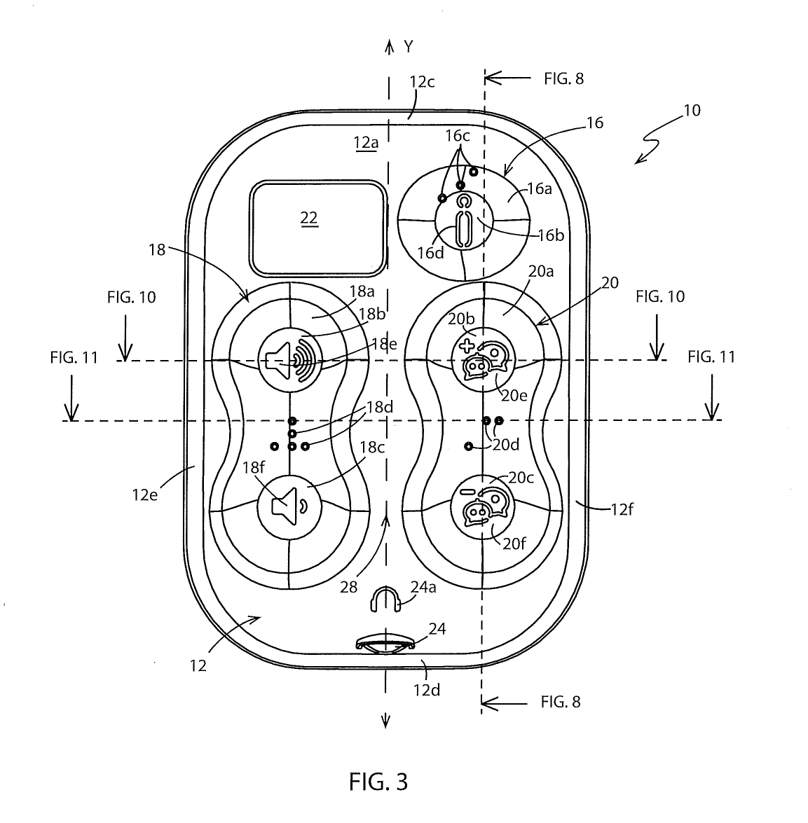

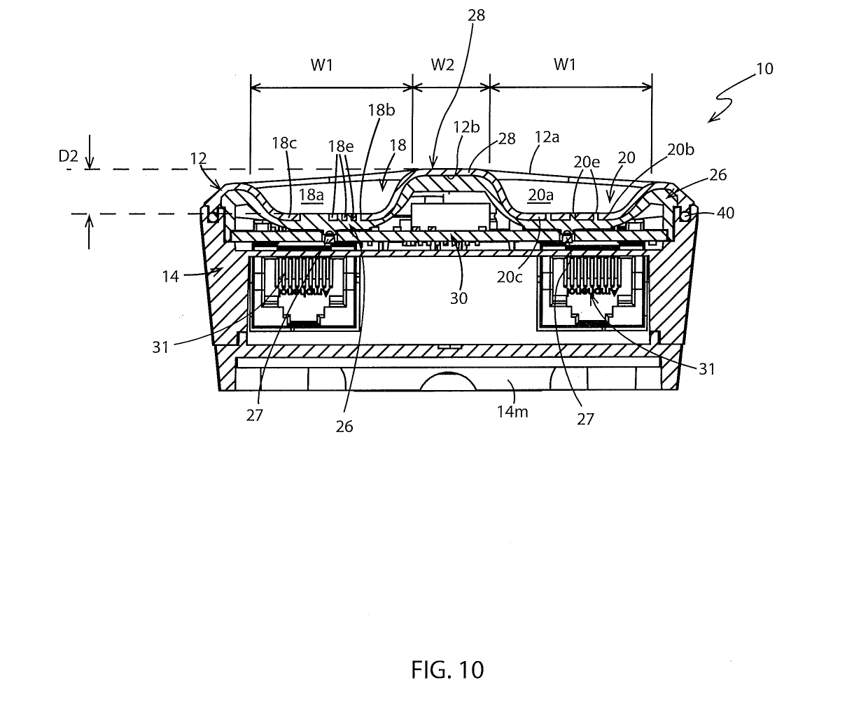

Upper housing 12 may include a top wall that has an exterior surface 12a, an interior surface 12b (FIG. 10), a first end 12c (FIG. 3), a second end 12d, a first side 12e, and a second side 12f. Exterior surface 12a provides a user contact surface that includes tactile controls that enable a user to operate user controller 10. The tactile controls will be discussed in greater detail hereafter.

First and second ends 12c, 12d and first and second sides 12e, 12f, of upper housing 12 extend downwardly at an angle from a peripheral edge of the top wall. FIG. 3 shows that user controller 10 may have a longitudinal axis “Y” that is generally oriented at right angles to first end 12c and second end 12d. First and second ends 12c, 12d may be generally at right angles to longitudinal axis “Y” and first and second sides may be generally parallel to longitudinal axis “Y”.

In accordance with an aspect of the present invention, upper housing 12 defines one or more depressions therein. The depressions are provided to delineate control button zones that may be accessed by a user. A first depression in upper housing 12 defines a first button zone that may be generally circular in shape when viewed from above and is generally indicated at 16. A second depression in upper housing 12 defines a second button zone, generally indicated at 18; and a third depression in upper housing 12 defines a third button zone, generally indicated at 20. Second and third button zones 18, 20 are substantially identical in shape and size; being generally shaped like the number “8” or these zones could be described as having the shape of a peanut shell.

First button zone 16 may include an inwardly sloped annular side wall 16a and a flat bottom wall 16b. The flat bottom wall 16b comprises an actuation region of the first button zone 16 although it will be understood that in other embodiments at least a part of the side wall 18a may comprise the actuation region. The inclined side wall 16a directs a user's finger downwardly into the button zone and towards a bottom wall 16b. Bottom wall 16b may be flat or planar in configuration and the inclined or slope side wall 16a extends upwardly and outwardly from a perimeter of the bottom wall 16b. The bottom wall 16b acts as a tactile control for user controller 10, i.e., a control that is operated by touching the same. The term “tactile control” should be understood to identify a component that is a “control button”, “actuator” or “switch” that is used to switch on, switch off or otherwise modify a function that may be performed by the user controller 10. These terms (i.e. tactile control, control button, actuator or switch may be used interchangeably herein. It should further be understood that the user may need only to place a fingertip on bottom wall 16b to actuate the control button. There may be no need to actually apply pressure to the control button in order to actuate the control button and thereby initiate or terminate a function of the user controller 10.

Braille indicia 16c are provided on side wall 16a and/or bottom wall 16b. Indicia 16c are raised buttons arranged to form a Braille word or symbol, First button zone 16 may also include graphic indicia 16d provided on bottom wall 16b. The Braille and graphic Indicia 16c, 16d are provided to be representative of and indicate a function that may be performed by user controller 10. The first button zone 16 may be considered a first control button for user controller 10. In particular, this first control button may be an “Information” button. The central control box may be programmed to deliver targeted advertising to the tourists. The user may contact flat region 16b in order to play a prerecorded message advising of special restaurant deals, other tours, places to visit or stay, museum locations and hours etc. that may be of interest to the tourist in the vicinity of the tour. The extra information is all user selected to limit unwanted audio chatter. Advertisers such as local pubs and restaurants may pay the tour operator a fee in order for their advertising to be featured on the user controller 10. This targeted advertising may be an important revenue generator for the tour operator over and above ticket prices for the tour itself.

Second button zone 18 may include an inwardly sloped side wall 18a and a pair of flat regions 18b, 18c that are spaced a distance longitudinally apart from each other. Flat regions 18b, 18c, like flat region 16b act as tactile controls for various functions that may be performed by user controller. The sloped side wall 18a angles upwardly and outwardly away from at least a portion of the perimeter of flat regions 18b, 18c and are useful to direct a user's fingers downwardly into the second button zone 18 and towards one or the other of flat regions 18b, 18c. The flat regions 18b, 18c may be separated from each other by a slightly raised region 28. Raised region 28 may be of a first width as measured between the first and second tactile controls, i.e., first and second flat regions 18b, 18c. Raised region 28 may further be of a first height as measured from one of the actuation regions (18b or 18c) to a upper surface of raised region 28. Raised region 28 is only slightly raised in height and fairly narrow in width because the control buttons at regions 18b, 18c are directed to related functions of user controller 10. In the illustrated instance, control buttons 18b, 18c are related to each other in that they are volume up/volume down tactile controls.

The presence of the inclined or sloped side wall 18a and a raised region 29 between second button zone 18 and third button zone 20 or between second button zone 18 and first button zone 16, helps separate unrelated control buttons from each other. An upper surface of raised region 29 is a greater distance away from control buttons 18b, 18c or 20b, 20c that is the upper surface of raised region 28. In other words, raised region 29 has a greater height that raised region 28. Additionally, raised region 29 may be of a greater width than raised region 28; in other words the distance between flat region 18b and flat region 20b is greater than the lateral distance between flat region 18b and flat region 18c; or between flat region 20b and flat region 20c. For example, the volume control buttons on flat regions 18b, 18c are separated from language control buttons on flat regions 20b, 20c in third button zone 20. The contours of user controller 10 therefore help a user tactilely discern where the various control buttons are located on user controller 10. For instance, the slightly raised region between flat regions 18b and 18c helps direct a user's fingers to one or the other of flat regions 18b or 18b. Braille indicia 18d are provided in the slightly raised region between the first and second flat regions 18b, 18c. This configuration helps a person with visual challenges to more readily interpret from the Braille which of the two flat regions 18b, 18c to select; namely the one above the raised region or the one below the raised region. Graphic indicia 18e are provided on first flat region 18b and different graphic indicia 18f are provided on second flat region 18c. As illustrated herein, graphic indicia 18e identify to sighted persons high/loud volume and graphic indicia 18f indicate lower/softer volume. The Braille indicia 18d convey this information as well so that the user knows whether to contact first flat region 18b or second flat region 18c to change the volume of the sound played by user controller 10.

Third button zone 20 may include an inwardly sloped side wall 20a and a pair of flat regions 20b, 20c that are spaced a distance longitudinally apart from each other. Flat regions 20b, 20c, like flat regions 18b, 18c are tactile controls for functions that are performable by user controller 10. Side wall 20a angles upwardly away from at least a portion of the perimeters of flat regions 20b, 20c. The sloped side wall 20a is used to direct a user's fingers downwardly into the third button zone 20 and towards one or the other of flat regions 20b, 20c. The flat regions 20b, 20c may be separated from each other by a slightly raised region in a similar manner and for the same purpose as the slightly raised region between flat regions 18b and 18c. The presence of the inclined or sloped side wall 20a and the raised region 29 helps separate third button zone 20 from the rest of upper housing 12, particularly from first button zone 16 and second button zone 18. The slightly raised region between flat regions 20b and 20c helps direct a user's fingers to one or the other of flat regions 20b or 20b. Braille indicia 20d are provided in the slightly raised region between the first and second flat regions 20b, 20c. This configuration helps a person with visual challenges to more readily interpret from the Braille which of the two flat regions 20b, 20c to select; namely the one above the raised region or the one below the raised region. Graphic indicia 20e are provided on first flat region 20b and different graphic indicia 20f are provided on second flat region 20c. As illustrated herein, graphic indicia 20e and 20f identify to sighted persons the language selections available through user controller 10. The user is able to move upwardly through a list of possible languages or tour topics by touching first flat region 20b and to move downwardly through the list of possible languages or tour topics by touching second flat region 20c. The Braille indicia 20d convey this information as well so that the user may select to contact first flat region 20b or second flat region 20c in order to select a language or tour topic in which to play the available prerecorded messages.

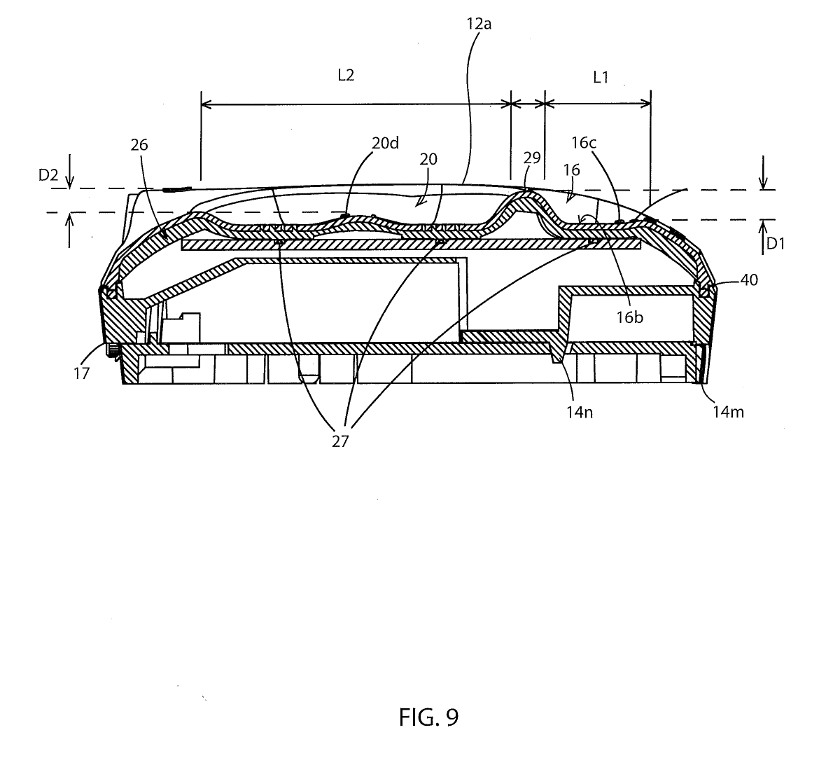

FIG. 9 is a longitudinal cross-section of user controller 10 showing first button zone 16 and third button zone 20. First button zone 16 may have a length “L1” and a depth “D1” at its deepest point relative to upper surface 12a. That deepest point may be where flat region 16b is located. Third button zone 20 may be of a length “L2” and of a depth “D1” relative to upper surface 12a in two locations, namely where flat region 20b and flat region 20c are located. Between flat region 20b and flat region 20c there may be a slightly raised region 28 that is only at a depth “D2” (where “D2” is less than “D1”). A raised region 29 may be located between first button zone 16 and third button zone 20 and it may be seen that an upper surface of raised region 29 may be essentially flush with the upper surface 12a (i.e., the user contact surface) of user controller 10. Raised region 29 creates a space between first button zone 16 and third button zone 20. When a user runs his or her fingertips over the user contact surface 12a, the user may readily feel that he or she is moving from a first area of tactile controls to a second region of tactile controls on the user controller 10.

FIG. 10 is a first lateral cross-section of user controller 10 taken at a first location and showing the first flat regions in each of the second and third button zones 18, 20. FIG. 10 shows that second button zone 18 may be of a width “W1” and, likewise, third button zone 20 may be of a width “W1”. Both of the flat regions 18b, 20b of second button zone 18 and third button zone 20, respectively, may be of a depth “D2” relative to upper surface 12a. Raised region 29 separates second button zone 18 from button zone 20 and creates a space of a width “W2” between second and third button zones 18, 20. Width “W2” may be less than the widths “W1”. It should be noted that when the tactile controls are directed to a similar function (such as tactile controls 18b, 18c) then the raised region 28 separating them is narrower in width and shorter in height than the raised region 29 provided when the tactile controls are directed to dissimilar functions of the user controller (such as tactile controls 18b and 20b). This difference in the contouring of the user contact surface 12a of user controller 10 helps a user easily navigate around contact surface 12a from one actuation region to another.

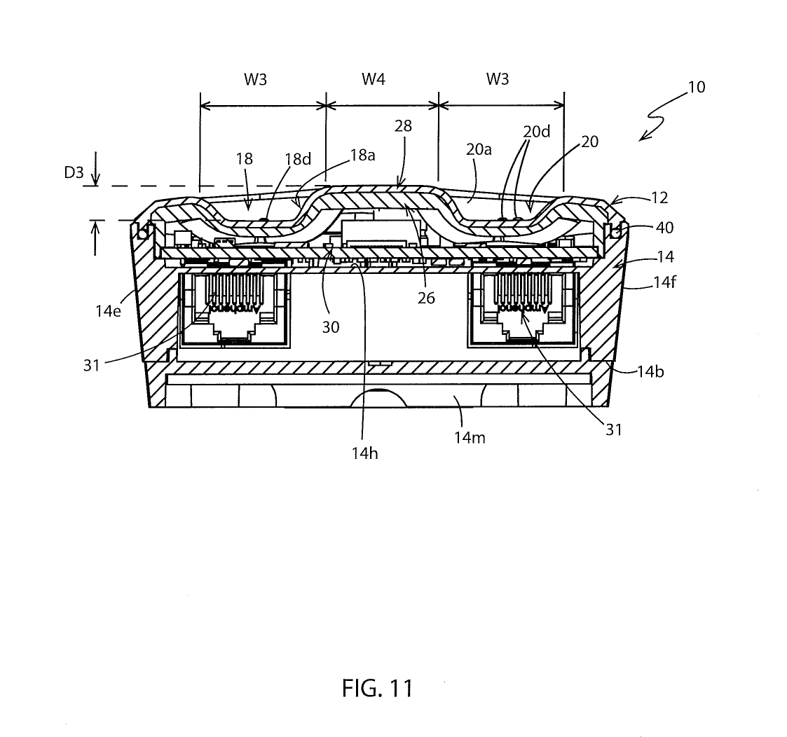

FIG. 11 is a second lateral cross-section of user controller 10 taken at a second location and showing the slightly raised region between the first and second flat regions of each of the second and third button zones 18, 20. FIG. 11 shows that at this location, second button zone 18 is of a width “W3” and, likewise, third button zone 20 is of a width “W3”. Both of the slightly raised regions of second button zone 18 and third button zone 20, respectively, are of a depth “D3” relative to upper surface 12a. Raised region 28 separates second button zone 18 from their button zone 20 and at this location is of a width “W4” between second and third button zones 18, 20. Width “W4” is greater than the widths “W3”. (It should also be noted that width “W3” is smaller than width “W1” and the width “W4” is greater than the width “W2”.)

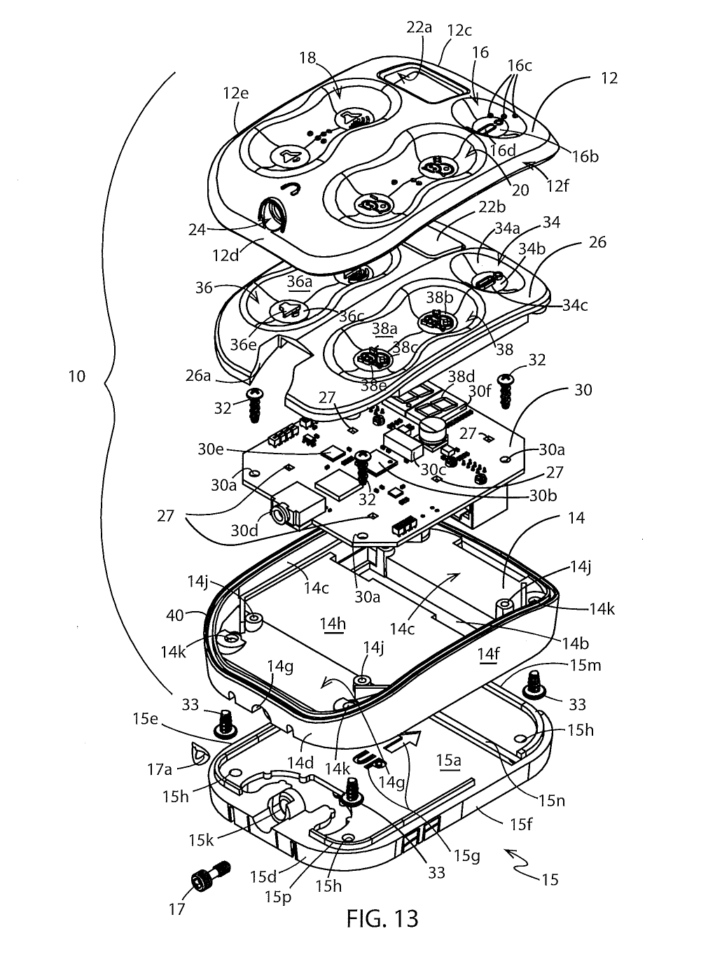

Upper housing 12 also may include a display screen 22 that displays digital information thereon, as will be described later herein. Upper housing 12 may define an aperture 22s (FIG. 13) that extends between the exterior and interior surfaces 12a, 12b of upper housing 12. Display screen 22 may extend through the aperture 22a from below. Upper housing 12 also may include a headphone jack 24 for plugging in a listening accessory including but not limited to headphones, earbuds, single earpieces, and teleloops for the hearing impaired. Graphic symbol 24a indicates to the user what the adjacent headphone jack 24 is provided for on upper housing 12. It should be noted that display screen is substantially flush with upper surface 12a and because the cover 22b is fabricated from a transparent material, display screen 22 will feel different from the rest of upper housing 12. The difference in materials will also aid the user in lower light conditions to tactilely discern what part of the user controller 10 they are contacting so that they can control the same.

It will be understood by those of ordinary skill in the art that the first, second and third button zones 16, 18, 20, the display screen 22 and headphone jack 24 may be differently shaped and may be located in different places on upper housing 12 from what is illustrated in the figures. However, the particular configuration shown in FIG. 1, for example has been found to be an easy to use, efficient and useful arrangement for a user controller 10. Similarly, the particular graphic indicia 16d. 18e, 18f, 20e, 20f and the associated Braille lettering 16c, 18d, 20d has been found to be readily understood by people from multiple languages and cultures and by persons who are blind or visually impaired.

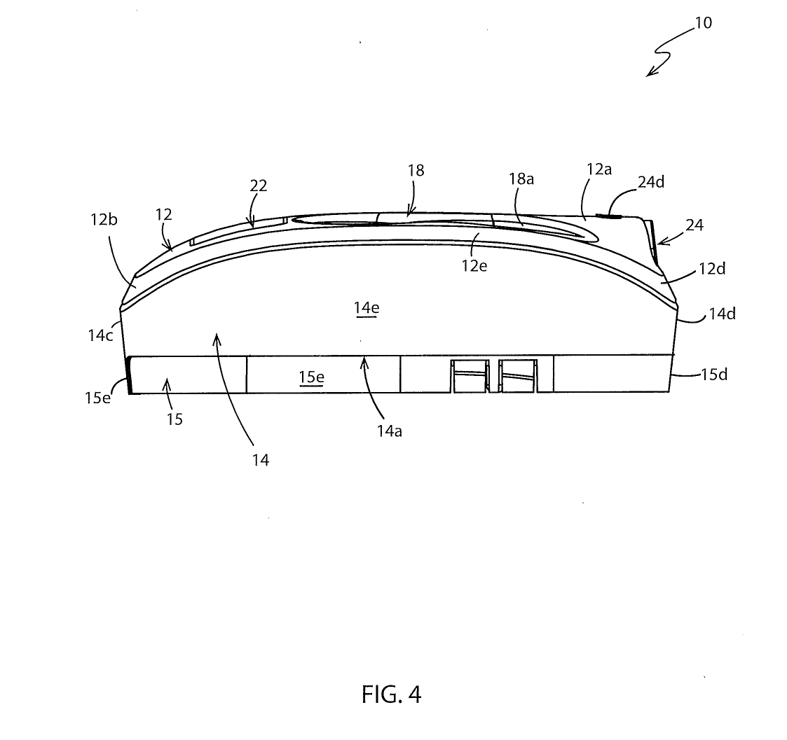

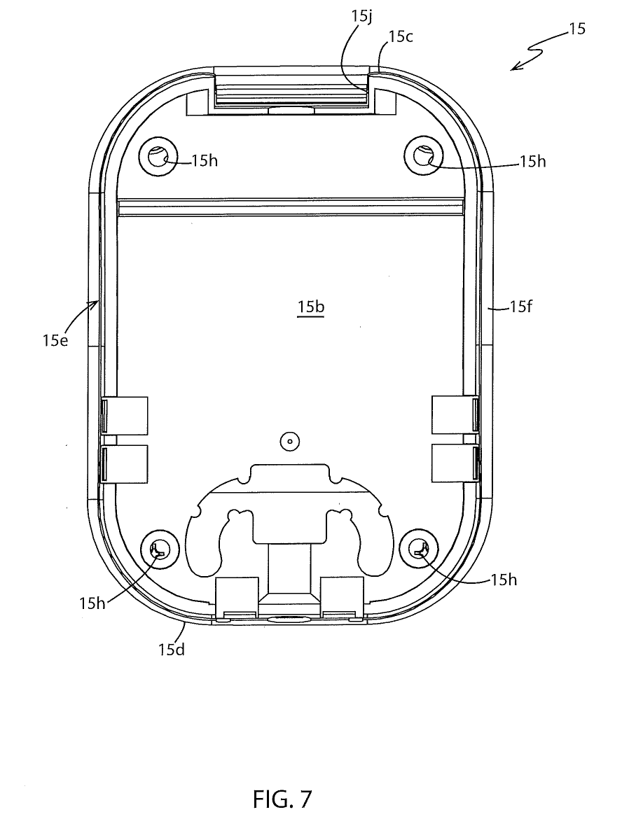

As indicated in FIG. 4, some or all of the graphic symbols may be raised relative to the surface of upper housing 12 to which they are applied. For example, the graphic symbol 24a for the headphone jack 24 may be raised relative to the exterior surface 12a of upper housing 12. FIG. 7 shows that graphic indicia 20e, 20f may be fabricated from a transparent or translucent material and may be illuminated to display a symbol that identifies to a user what function is controlled by contacting that region of the user controller 10. A lightpipe 26 may be provided below the entire interior surface of upper housing 12 to illuminate graphic indicia 20e, 20f. In other instances, individual lightpipes may serve this function. This under-lighting or backlighting makes it possible for a user to see the graphic indicia 20e, 20f (and 18e, 18f, 16d) more readily in low-lighting conditions or in the dark than would be the case if the graphic indicia were illuminated from above.

It should also be noted that a raised region 28 (FIG. 10) of the upper housing is located between second button zone and third button zone. The raised region 28 is essentially a spacer that readily separates the two zones of controls and makes it easy for a user to locate the controls by touch even if they initially cannot be seen in lower lighting conditions.

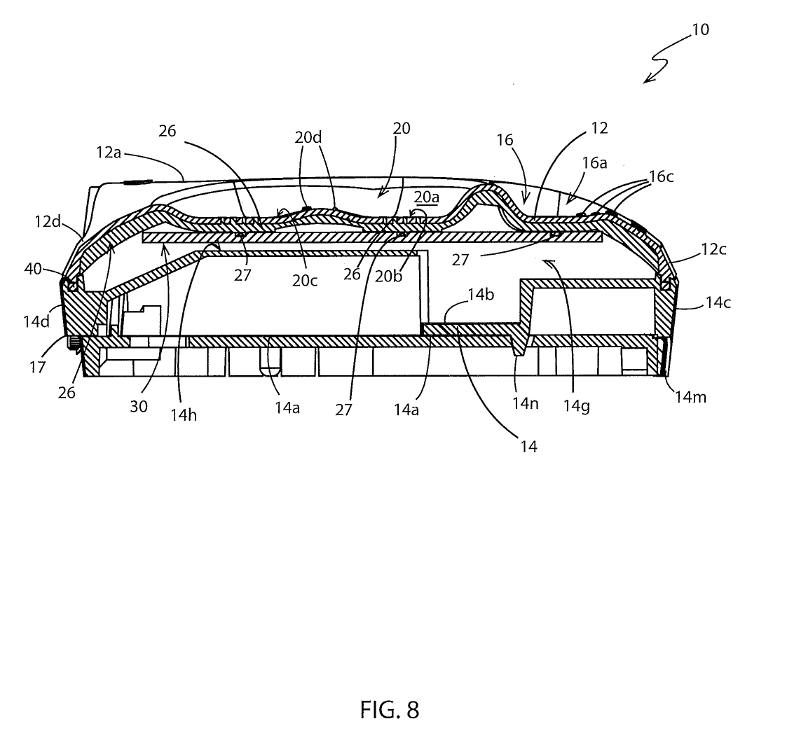

Lower housing 14 is shown in greater detail in FIGS. 8 and 13. Lower housing 14 may include a bottom wall that has an exterior surface 14a (FIG. 9) and an interior surface 14b (FIG. 13). Interior and exterior surfaces 14a, 14b are configured to be complementary to mounting bracket 15 so that lower housing 14 may be selectively engaged with mounting bracket 15 as will be later described herein. Lower housing 14 also may include a first end 14c (FIG. 13), a second end 14d, a first side 14e and a second side 14f. Interior surface 14b, first and second ends 14c, 14d, and first and second sides 14e, 14f, bound and define an interior cavity 14g.

Lower housing 14 may include a number of mountings, such as mounting platform 14h that are used to support various components which are received within interior cavity 14g. For example, a Printed Circuit Board (PCB) 30 is seated on mounting platform 14h and is retained within cavity 14g by one or more fasteners 32. Fasteners 32 are inserted through apertures 30a defined in PCB 30 and are threadably engaged into screw mounts 14j. A plurality of mounting holes 14k are defined in the bottom wall, extending between exterior surface 14a and interior surface 14b. A reinforcing ring may be provided around each hole 14k. Mounting holes 14k are used to receive fasteners 33 to secure lower housing 14 (and thereby user controller 10) to mounting bracket 15 as will be described later herein.

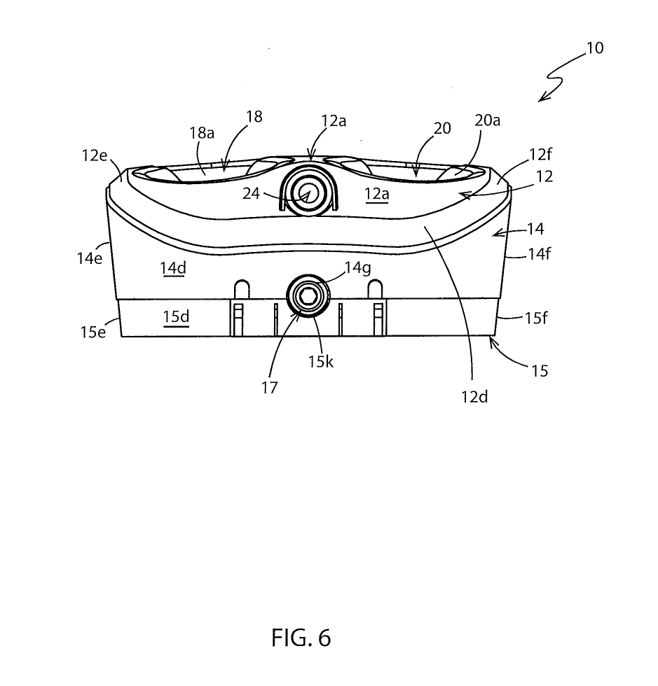

FIGS. 4, 8, 10 and 11 show that a plurality of leg members 14m, 14n and 14p extend outwardly from exterior surface 14a of lower housing 14. Leg members 14m, 14n and 14p are longitudinally spaced from each other and may be arranged such that they are oriented generally at right angles to a longitudinal axis “Y” of user controller 10. As can be seen from FIG. 4, leg member 14m may be longer than leg members 14n and 14p and leg members 14n, 14p may be of substantially the same length. (The length of each leg member 14m, 14n, 14p is the distance that each leg member extends outwardly away from exterior surface 14a of lower housing 14.) Leg member 14m may extend a distance “D” (FIGS. 4 and 6) further outwardly from exterior surface 14a than do either of leg members 14n or 14p. Leg members 14m, 14n, and 14p are configured to engage complementary regions of mounting bracket 15 in order to secure lower housing 14 to mounting bracket 15.

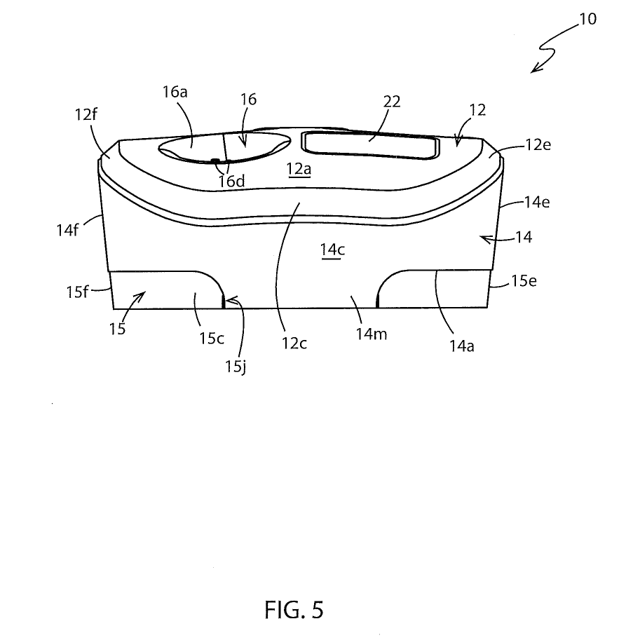

Mounting bracket is shown in greater detail in FIGS. 7 and 13. Mounting bracket 15 includes a bottom wall having an interior surface 15a and an exterior surface 15b, a first end 15c, a second end 15d, a first side 15e and a second side 15f. Mounting bracket's interior surface 15a is contoured so as to be complementary to the exterior surface 14a of lower housing 14. As shown in FIG. 13, interior surface 15a of mounting bracket 15 may include one or more graphic indicators 15g to show an installer which way to orient mounting bracket during installation on a mounting surface such as a sidewall, seatback etc. Mounting bracket 15 defines one or more holes 15h therein that extend between interior surface 15a and exterior surface 15b. Mounting bracket 15 further defines a recessed region 15j (FIG. 5) in first end 15c that is configured to receive leg member 14m therein to help secure mounting bracket 15 and lower housing 14 to each other. A passageway 15k may be defined in a recessed portion of second end 15d. The passageway 15k is alignable with a complementary passageway 14q (FIG. 6) defined in the exterior surface 14a of lower housing 14. When lower housing 14 is interlocked with mounting bracket 15, passageway 15k is brought into alignment with the complementary passageway in lower housing 14 and a fastener 17 is inserted therethough to secure lower housing 14 to mounting bracket 15. The interior surface 15a of mounting bracket 15 may further include ridges or recesses 15m, 15n and 15p that are configured to engage legs 14m, 14n and 14p of lower housing 14 when mounting bracket 15 and lower housing 14 are secured to each other.

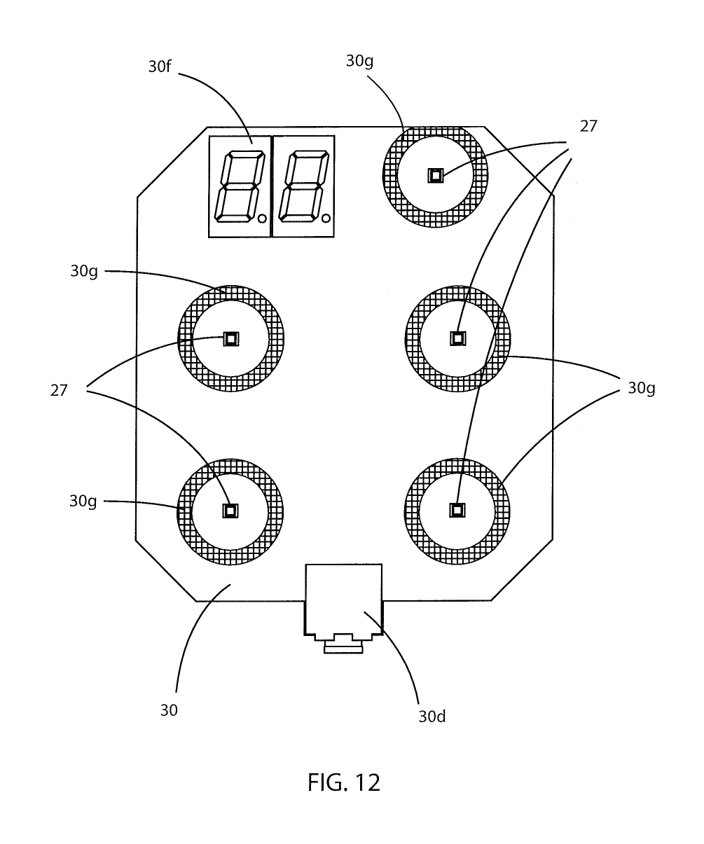

PCB 30 that is housing within the interior of user controller 10 may include a variety of components that enable user controller 10 to perform its desired function. For example, PCB 30 may include a microprocessor 30b, a power source 30c, an audio connector 30d, a sound output 30e and a Liquid Crystal Display (LCD) screen 30f. As shown in FIG. 11, user controller 10 may also include receptacles 31 (such as RJ 45 receptacles) for communication with microprocessor 30b. The PCB 30 is shown in FIG. 12 with all components removed except for LCD screen 30f, capacitive sensors 30g and light emitting diodes (LEDs) 27. It should be noted that the capacitive sensors 30g are each located on PCB 30 such that they fall directly under one or the other of the flat regions 16b, 18b, 18c, 20b or 20c. Capacitance sensors 30g therefore come in direct contact with all of the flat regions 16, 18b, 18c, 20b, 20c and therefore when the user places a fingertip on any of these flat regions, this contact is detected by the associated sensor 30g. This ensures that when a user places his or her fingertip on a selected one of the flat regions 16b, 18b, 18c, 20b, 20c, the capacitive sensor 30g will be activated and the function operatively linked to that particular sensor 30g will be actuated. Other components may be provided on PCB 30 but are not specifically identified herein. It should also be understood that appropriate circuitry is provided on PCB 30 but is not illustrated herein.

Referring still to FIGS. 8, 12 and 13, lightpipe 26 is provided as part of user controller 10. Lightpipe 26 is fabricated from a clear plastic and is located so that one or more LEDs 27 provided on PCB may be used to illuminate all control buttons on user controller 10. Lightpipe 26 is a device that is substantially complementary in shape and size to the interior surface 12b of the top wall of upper housing 12. Lightpipe 26 may be nestingly engaged with upper housing 12 in such a manner that the interior surface 12b of upper housing 12 abuts an exterior surface of lightpipe 26. Lightpipe 26 may include a first button zone 34 that is complementary to first button zone 16; a second button zone 36 that is complementary to second button zone 18; and a third button zone 38 that is complementary to third button zone 20. First button zone 34 may include an inwardly sloping annular wall 34a and a flat region 34b. Indicia 34c identical to indicia 16b may also be provided on flat region 34b. Second button zone 36 is shaped like the number “8” or like a peanut shell and may include an inwardly sloping wall 36a and a first and second flat region 36b, 36c. Indicia 36d, 36e identical to indicia 18e, 18f may also be provided in first and second flat regions 36b, 36c. Third button zone 38 is shaped like the number “8” or like a peanut shell and may include an inwardly sloping wall 38a and a first and second flat region 38b, 38c. Indicia 38d, 38e identical to indicia 20e, 20f may also be provided in first and second flat regions 38b, 38c. Lightpipe 26 may also include a notch 26a that is shaped to fit around the audio connector 30d on PCB 30.

Lightpipe 26 may include a cover 22b for display screen 22. Cover 22b may be fabricated from a transparent material such a clear plastic that is complementary in shape and size to aperture 22a defined in upper housing 12. Cover 22b protects digital display 30f provided on PCB 30 but also ensures that the information displayed by digital display 30f is readily seen. Lightpipe 26 is operatively engaged with PCB 30 and is illuminated when activated and is used to backlight the flat regions 16b, 18b, 18c, 20b, and 20c of upper housing 12 in particular.

User controller 10 is assembled by placing PCB 30 on platform 14h in interior cavity 16g of lower housing 14. Lightpipe 26 is placed on top of PCB 30 and upper housing 12 is placed over lightpipe 26 and is operatively engaged with lower housing 14. As can be seen in FIGS. 8-11, a seal 40 may be positioned between a bottom edge of upper housing 12 and a top edge of lower housing 14. Seal 40 helps ensure that moisture will not make its way into the interior cavity 14g and damage any of the components therein.

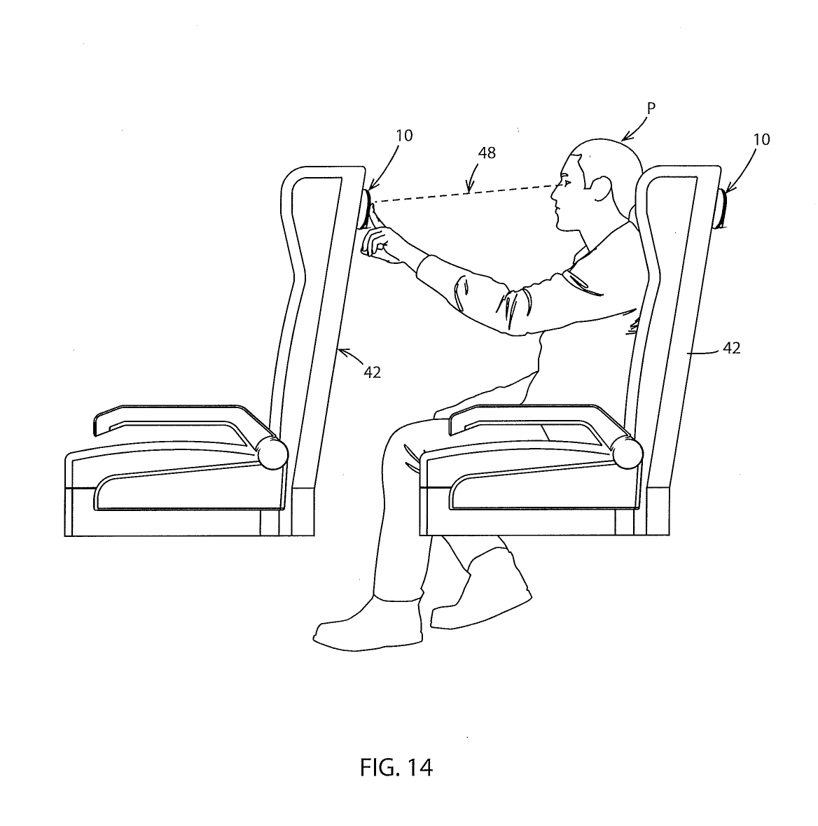

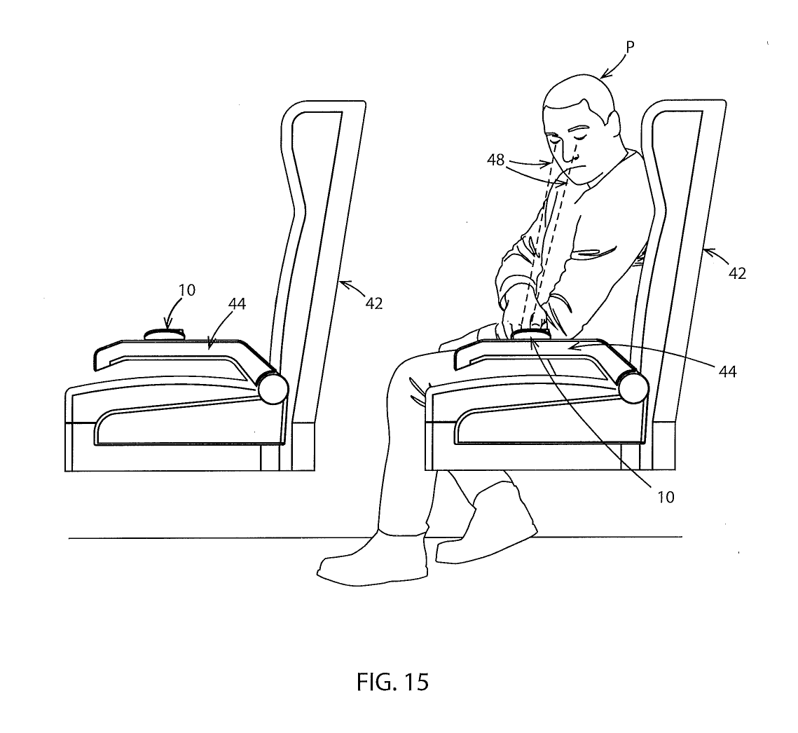

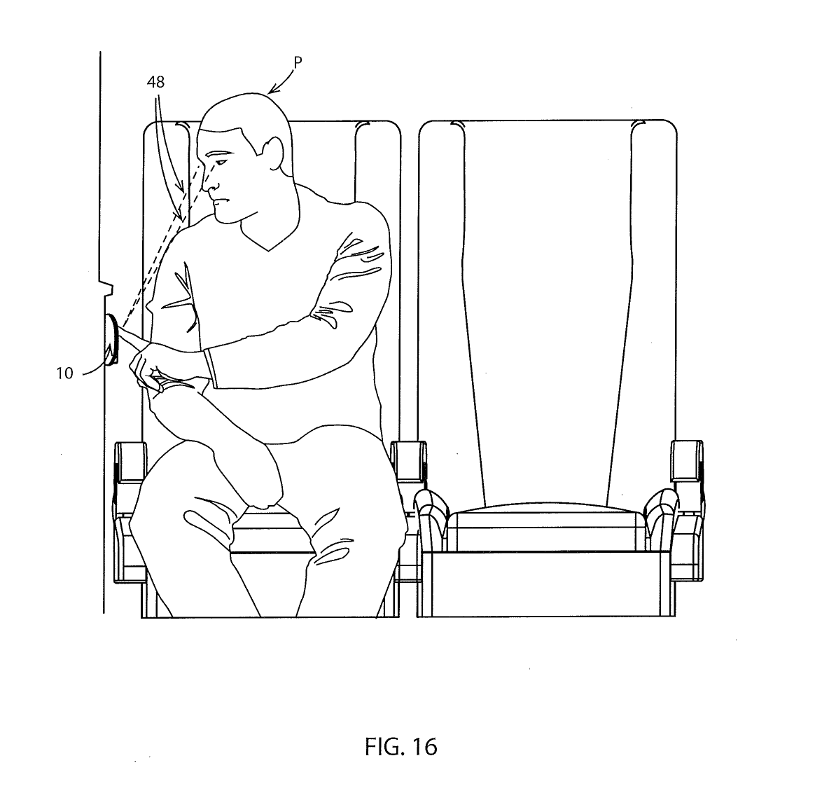

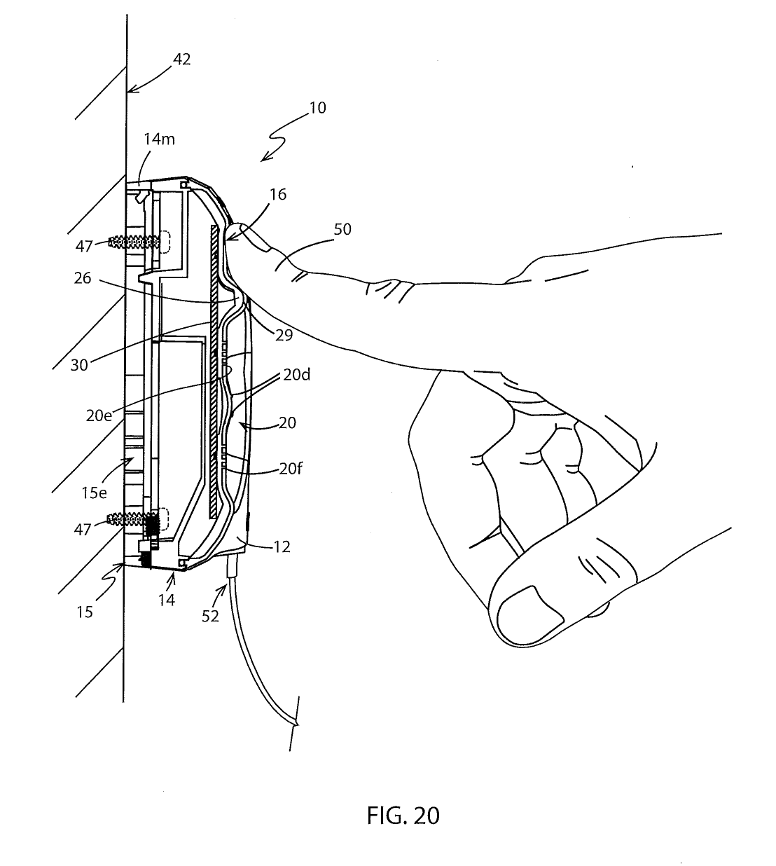

User controller 10 may then be mounted on a seatback 42 (FIG. 14), an armrest 44 (FIG. 15), or a vertical wall 46 (FIG. 16) of a vehicle or vessel. User controller 10 may be mounted on seatback 42, armrest 44 or wall 46 by inserting fasteners 47 (FIG. 20) through holes 15h in mounting bracket 15 to secure mounting bracket 15 to seatback 42, armrest 44 or wall 46. Different types of fastener 47 may be utilized for mounting on different support surfaces and the type of fastener 47 illustrated herein should be understood to be an example of one type of fastener that may be used.

Graphic indicators 15g are utilized by the installer to ensure mounting bracket 15 is correctly oriented on seatback 42, armrest 44 or wall 46. Once mounting bracket 15 is installed, legs 14m, 14n, 14p of lower housing 14 are interlocked with mounting bracket 15 and fastener 17 is inserted through passageways 14q, 15k to lock mounting bracket 15 and the rest of user controller 10 together. A retaining ring washer 17a (FIG. 13) may also be used to capture fastener 17. User controller 10 is then ready for use.

In each of the installations shown in FIGS. 14, 15 and 16, the user “P” has a good line of sight 48 to the user controller 10 and can readily see display screen 22 and the various backlighted control buttons 16b, 18b, 18c, 20b, 20c. The preferred mounting location for user controller 10 is on a seatback 42 such as illustrated in FIG. 14. This mounting location is preferred simply because the user “P” can look straight ahead and clearly see the display screen 22 and control buttons in first, second and third button zones 16, 18, 20. The mounting location shown in FIG. 15 requires that the viewer use an opposite arm to operate user controller 10 and his line of sight 48 tends to be slightly skewed. Similarly, with a wall mounting as is shown in FIG. 16, the user's line of sight 48 may be skewed and he or she may need to use an opposite arm to operate user controller 10.

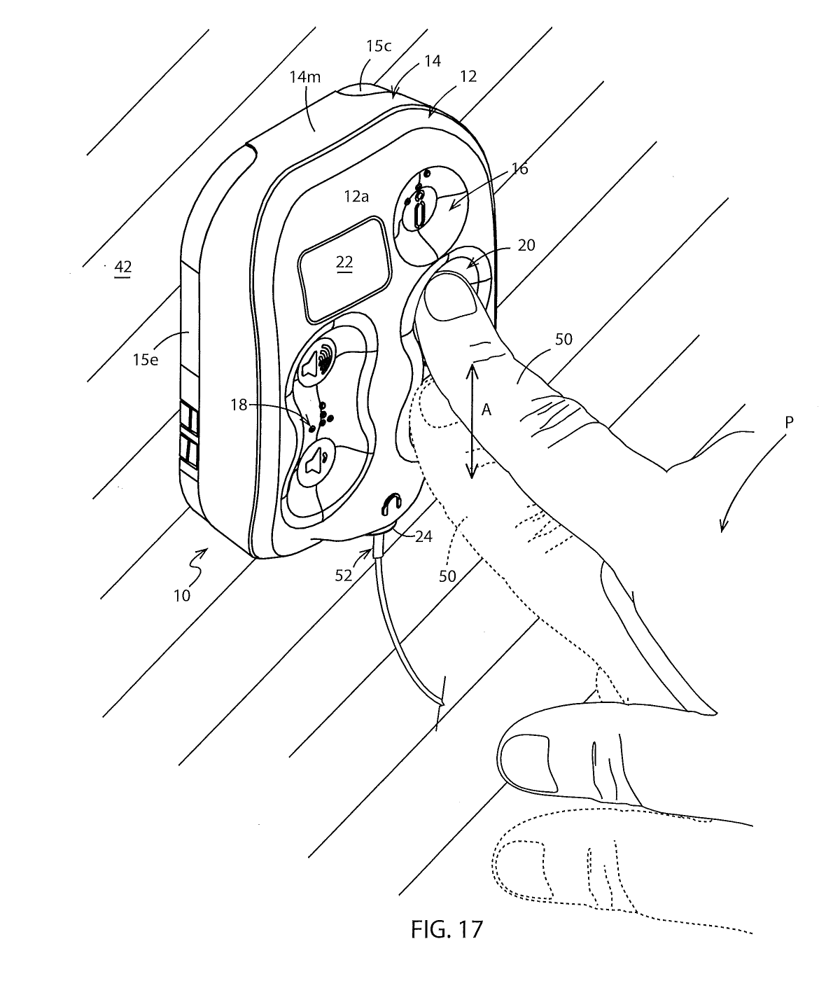

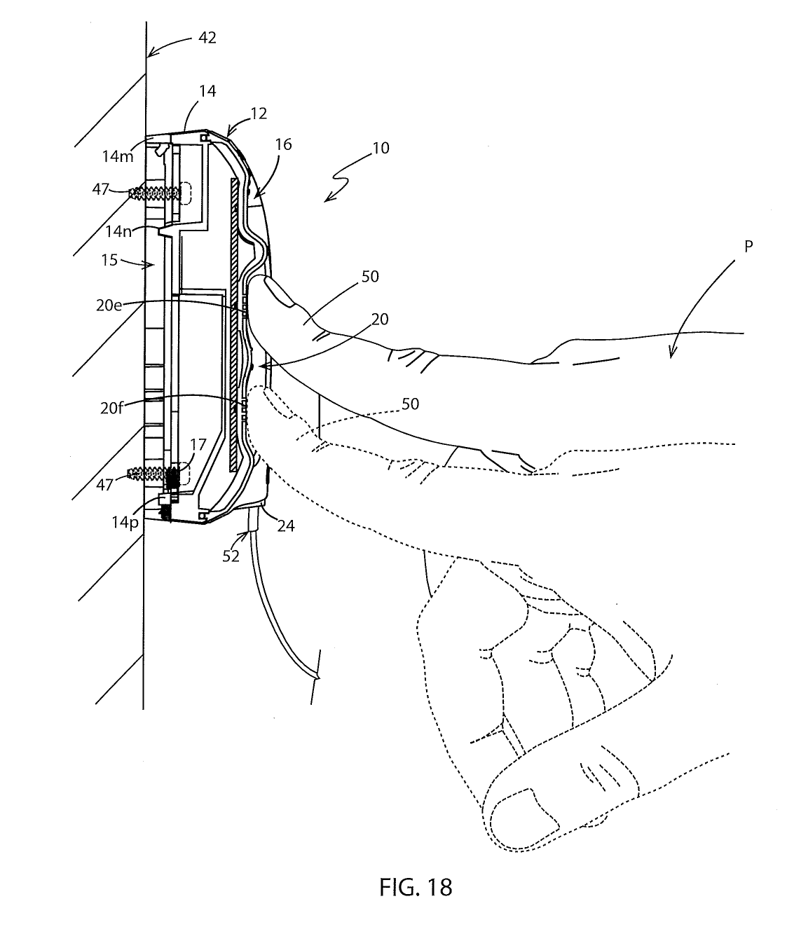

FIGS. 17 and 18 show a hand of a user “P” positioned such that the tip of their index finger 50 is in contact with the first flat region 20b of third button zone 20. The user is therefore actuating the language control button 20e. The user will hold their index finger 50 on control button 20e to move through the list of available languages or tour topics. The languages or tour topics will be displayed on display screen 22 and will be listed audibly. The user can check display screen 22 to select the desired language or can hear the list through headphones 52 engaged in headphone jack 24. If the user accidentally moves past the desired language, the user can slide their index finger from control button 20e to control button 20f to reverse the list of languages or tour topics. The position of index finger 50 in control button 20f is shown in phantom in FIGS. 17 and 17. The sliding movement between control button 20e and 20f is shown by the arrow “A”. If the user is sight impaired, he or she may move over the Braille indicia 20d to find appropriate instructions to select their desired language. Once the appropriate tactile control has been activated by the user, the microprocessor 30b is actuated and since microprocessor 30b is programmed to have user controller 110 play a plurality of pre-recorded messages in a plurality of different languages or tour topics, the user will be able to hear a specific pre-recorded message in the desired language. It should be noted that the selections made by the user for various functions of the user controller 10 will be confirmed on display screen 22.

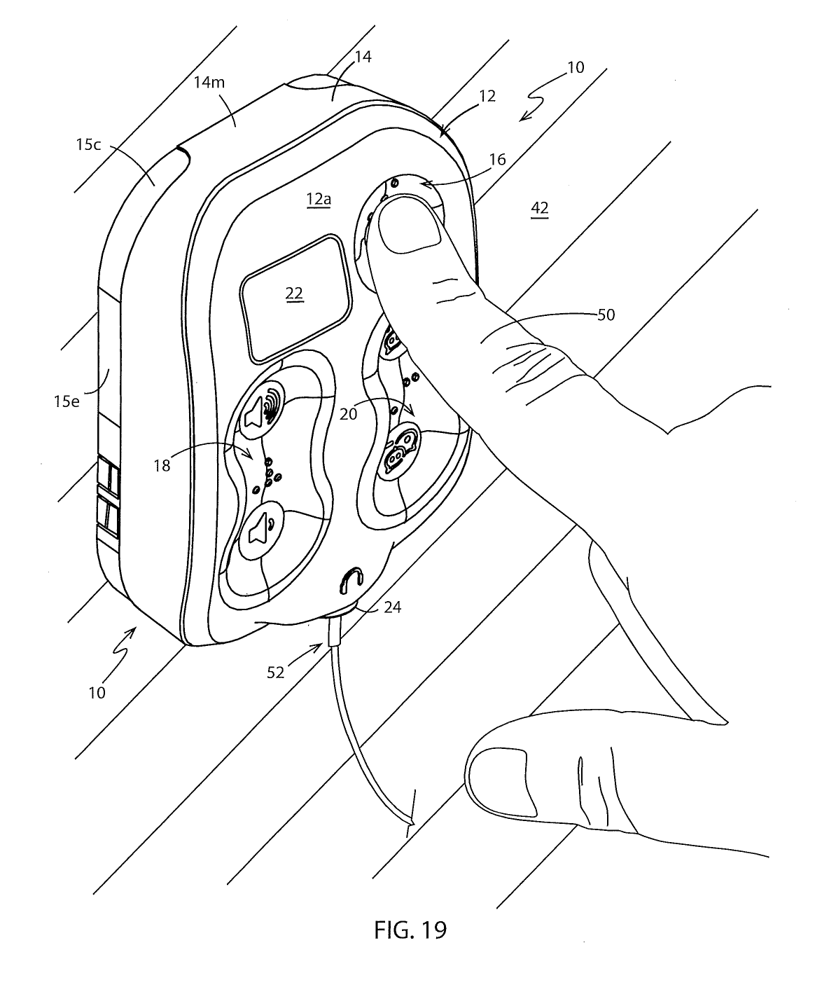

It will be understood that second button zone 18 may be used in the same manner to adjust the volume of the preprogrammed messages that are delivered by user controller 10. First button zone 16 may be used by placing a fingertip, such the tip of index finger 50 on the flat region 16d to hear information and advertising paid for by local businesses and services. This activation of the information button is shown in FIGS. 19 and 20.

In order for a user to operate user controller 10 they simply need to place a fingertip into the appropriate depression 16, 18 or 20 and place their fingertip onto the associated flat region 16b, 18b,18c, 20b, 20c in order to control the features of user controller 10. The user does not need to apply pressure to the flat region but simply contacting the desired region will actuate the associate capacitance sensor 30g. Since the capacitance sensors 30g are operatively engaged with the microprocessor 30b, the contact will result in the desired feature of the user controller 10 being activated. Microprocessor 30b may be provided with programming that is designed specifically to operate the various features of user controller 10. User controller 10 may be in wired or wireless communication with the central control box provided on the vehicle or vessel (or even at a location remote from the vehicle or vessel.) Instead of microprocessor 30b being specifically programmed to operate user controller 10, the central control box may be the unit that may include programming that is configured to operate the plurality of user controllers 10 on a vessel or vehicle. In these instances, actuation of the capacitance sensors 30g will result in a signal being sent from microprocessor 30b to the central control box. In response, the programming in the central control box will be activated and will control the desired feature of user controller 10.

User controller 10 may include two different types of control buttons. The first type of control button is a single selection type button (i.e., an on/off type button). The second type of control button is a multiple selection type button where there are a range of possible selections, e.g. volume control up or down. All of the control buttons (i.e., flat regions 16b, 18b, 18c, 20b, 20c are deeply recessed relative to front surface 12a of upper housing since they are located at the bottom of the depressions that form the first, second and third button zones 16, 18, 20. The depressions 16, 18, 20 have subtle complex 3-Dimensional (3D) shapes and widths. These shapes help guide the user when the ambient lighting is low or too bright or when or viewing and finger angles are challenging. In other words, user controller 10 provides the user with tactile information that aids them in low lighting conditions or when lighting is very bright and the control buttons cannot easily be seen. The user may then use their fingers and hands to feel the depressions on upper housing 12 and are thus aided in finding the right control button since they know the button is going to be located in one of the three depressions 16, 18, or 20 in the upper housing 12. Furthermore, if the user's fingers are placed in one of the depressions 16, 18, 20 it is intuitive as to where to find the other depressions 16, 18 or 20 on user controller 10.

All of the control buttons are backlit by lightpipe 26 and one or more LEDs 27 (FIGS. 10 and 12) and, consequently, all of the control buttons are more readily seen when ambient lighting is not optimal. Digital display 22 also allows the user controller 10 to prompt the user and also to display the user's selections so that the user can verify that is the selection they have made. For instance, if the user selects to listen to a message in German, the digital display 22 will indicate the selected language is German so that the user can know the correct language is going to be utilized.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the disclosure are an example and the disclosure is not limited to the exact details shown or described.

1. A tactile user controller for an audio system comprising:
a housing adapted to be mounted on a support surface; wherein the housing includes:
a user contact surface; and
one or more tactile controls provided on the user contact surface; wherein the one or more tactile controls are recessed within the user contact surface.

2. The tactile user controller as defined in claim 1, wherein each of the one or more tactile controls comprises:
a actuation region; and
an annular wall extending upwardly and outwardly from a perimeter of the actuation region.

3. The tactile user controller as defined in claim 2, further comprising a capacitance sensor positioned adjacent an interior surface of the one or more tactile controls.

4. The tactile user controller as defined in claim 3, wherein the capacitance sensor is positioned adjacent an interior surface of the actuation region.

5. The tactile user controller as defined in claim 2, further comprising a graphic indicator defined in the actuation region; wherein the graphic indicator is representative of a function performable by the audio system.

6. The tactile user controller as defined in claim 5, wherein the graphic indicator is fabricated at least partially from transparent material; and wherein the tactile user controller further comprises a light source positioned to illuminate the graphic indicator.

7. The tactile user controller as defined in claim 6, wherein the light source comprises a lightpipe located beneath an interior surface of the user control surface and the lightpipe backlights the graphic indicator.

8. The tactile user controller as defined in claim 1, wherein the one or more tactile controls include a first tactile control and a second tactile control; and wherein the user contact surface further comprises:
a first raised region separating the first tactile control from the second tactile control; wherein the first raised region is of a first width as measured between the first tactile control and the second tactile control and is of a first height measured from a actuation region of the first tactile control or a actuation region of the second tactile control to a top of the first raised region.

9. The tactile user controller as defined in claim 8, wherein when the first tactile control and the second tactile control are directed to controlling similar functions of the tactile user controller, then the first width of the first raised region is smaller than when the first tactile control and the second tactile control are directed to controlling dissimilar functions of the tactile user controller.

10. The tactile user controller as defined in claim 8, wherein when the first tactile control and the second tactile control are directed to controlling similar functions of the tactile user controller, then the first height of the first raised region is smaller than when the first tactile control and the second tactile control are directed to controlling dissimilar functions of the tactile user controller.

11. The tactile user controller as defined in claim 1, further comprising a digital display screen provided on the user contact surface a distance laterally away from the one or more tactile controls.

12. The tactile user controller as defined in claim 1, further comprising Braille indicia on an exterior of the user contact surface; wherein the Braille indicia are related to at least one of the one or more tactile controls and are adapted to inform users as to functions performed by the one or more tactile controls.

13. The tactile user controller as defined in claim 1, further comprising a microprocessor operatively engaged with the one or more tactile controls; wherein the microprocessor is provided with programming that controls a plurality of different functions of the tactile user controller.

14. The tactile user controller as defined in claim 13, wherein the microprocessor is programmed to have the user controller play a plurality of pre-recorded messages in a plurality of different languages or tour topics upon activation of one of the one or more tactile controls.

15. The tactile user controller as defined in claim 14, wherein the microprocessor is mounted on a printed circuit board (PCB) retained within an interior of the housing of the tactile user controller; and wherein the PCB includes a plurality of capacitance sensors mounted thereon, each of the plurality of capacitance sensors being operatively engaged with the microprocessor and with one of the one or more tactile controls.

16. The tactile user controller as defined in claim 1, wherein one of the one or more tactile controls is an information button that, when actuated, provides pre-recorded advertising to a user of the user controller.

17. A method of operating a user controller of an audio system comprising:
providing a user controller that includes a housing with a user contact surface with one or more tactile controls provided thereon; wherein each of the one or more tactile controls is recessed within the user contact surface;
selecting a first tactile control from the one or more tactile controls;
placing a fingertip onto a first actuation region provided on the first tactile control; and
actuating a first function of the user controller associated with the first tactile control.

18. The method as defined in claim 17, wherein the placing of the fingertip is followed by:
activating a capacitance sensor located beneath an interior surface of the first actuation region of the first tactile control;
activating a microprocessor operatively engaged with the first actuation region when the fingertip is placed on the actuation region; and
controlling the first function with the microprocessor.

19. The method as defined in claim 18, further comprising;
selecting a second tactile control from the one or more tactile controls;
sliding the fingertip from the first actuation region of the first tactile control up a first sloped wall, over a first raised region and down a second sloped wall to a second actuation region;
activating a capacitance sensor located beneath an interior surface of the second actuation region; and
actuating a second function of the user controller associated with the second tactile control.

20. The method as defined in claim 19, wherein the sliding over the first raised region includes moving for a first distance upwardly along the first sloped wall to an upper surface of the first raised region when the first function and second function are related to each other; and the sliding over the first raised region includes moving upwardly along the first sloped wall to the upper surface of the first raised region for a second distance when the first function and second function are unrelated; and wherein the second distance is greater than the first distance.

21. The method as defined in claim 19, further comprising:
displaying information about the first function on a display screen provided on a user contact surface of the user controller.

22. The method as defined in claim 18, further comprising:
Illuminating a graphic display provided on the actuation region of the first tactile control.

23. The method as defined in claim 17, further comprising playing a pre-recorded message when the first tactile control is contacted.

24. The method as defined in claim 23, wherein the playing of the pre-recorded message comprises playing pre-recorded advertising messages or information messages directed to an area surrounding a location of the user controller.

25. The method as defined in claim 17, further comprising:
utilizing global positioning satellite (GPS) technology programmed into a microprocessor of a master control box for multiple user controllers or of a vessel or vehicle in which the user controller is used to determine a global location of the user controller; and
selecting and playing a pre-recorded message on the user controller based on the global location of the user controller.
